(19) United States
(12) Patent Application Publication
(10) Pub. No.: US 2026/0252195 A1
(43) Pub. Date: Aug. 27, 2026

(54) ELECTRONIC DEVICE AND METHOD OF DRIVING THE SAME

(71) Applicant: Samsung Display Co., Ltd., Yongin-si (KR)

(72) Inventors: Jeongheon LEE, Yongin-si (KR); Junghak KIM, Yongin-si (KR); Yun A MA, Yongin-si (KR); Jungha SON, Yongin-si (KR); Sangwook YOO, Yongin-si (KR)

(73) Assignee: Samsung Display Co., Ltd., Yongin-si (KR)

(21) Appl. No.: 19/389,486

(22) Filed: Nov. 14, 2025

(30) Foreign Application Priority Data
Feb. 24, 2025 (KR) 10-2025-0023442

(51) Int. Cl. G06F 3/041; G06F 3/044

(52) U.S. Cl. CPC G06F 3/04186; G06F 3/04166; G06F 3/04182; G06F 3/0446; G06F 2203/04105

(57) ABSTRACT

An electronic device, which includes a sensor layer including a touch sensor for detecting a touch input and a pressure sensor for detecting a pressure, a sensor driver that drives the sensor layer in units of sensing frames and including a sensor control circuit, and a processor that controls an operation of the sensor driver. In response to the pressure sensing value being greater than a pressure threshold value, the sensor control circuit outputs a coordinate signal to the processor after a first delay time from an input time when the touch input occurs, and in response to the pressure sensing value is less than the pressure threshold value, the sensor control circuit outputs the coordinate signal to the processor after a second delay time from the input time. The first delay time is less than the second delay time.

### CROSS-REFERENCE TO RELATED APPLICATIONS

This U.S. non-provisional patent application claims priority under 35 U.S.C. § 119 to Korean Patent Application No. 10-2025-0023442, filed on Feb. 24, 2025, in the Korean Intellectual Property Office, the disclosures of which are incorporated by reference herein in their entireties.

### BACKGROUND

Example embodiments of the present disclosure described herein relate to an electronic device and method of driving the same, and more particularly, relate to an electronic device capable of improving response speed and a method of driving the same.

Electronic devices may include a display layer that displays an image, a display driving unit that transmits a signal to the display layer, a sensor layer located on the display layer, and a sensor driving unit that transmits a driving signal to the sensor layer.

The sensor layer is a type of information input device and may be equipped and used in the electronic device. For example, the sensor layer may be attached to one side of the display layer or may be manufactured as an integral part of the display layer. A user may input information by pressing or touching the sensor layer while viewing an image displayed on the screen of the electronic device.

### SUMMARY

Example embodiments of the present disclosure provide an electronic device capable of improving response speed and a method of driving the same.

According to an example embodiment of the present disclosure, an electronic device includes a sensor layer including a touch sensor for detecting a touch input and a pressure sensor for detecting a pressure, a sensor driver that drives the sensor layer in units of sensing frames and including a sensor control circuit, and a processor that controls an operation of the sensor driver. The sensor control circuit includes a receiving unit that receives sensing data including a touch sensing value and a pressure sensing value, and a pressure determination unit that determines whether pressure occurs based on the pressure sensing value, and when the pressure sensing value is greater than a pressure threshold value, the sensor control circuit outputs a coordinate signal to the processor after a first delay time from an input time when the touch input occurs, when the pressure sensing value is less than the pressure threshold value, the sensor control circuit outputs the coordinate signal to the processor after a second delay time from the input time, and the first delay time is less than the second delay time.

According to an example embodiment, during the first delay time, one sensing frame may be included, and during the second delay time, n+1 sensing frames may be included. Where, “n” is an integer greater than or equal to “1”.

According to an example embodiment, the one sensing frame included in the first delay time may be an active frame, and one sensing frame among the n+1 sensing frames included in the second delay time may be the active frame, and each of the remaining “n” sensing frames may be a holding frame.

According to an example embodiment, the holding frame included in the second delay time may precede the active frame included in the second delay time.

According to an example embodiment, after the holding frame ends, the coordinate signal may not output to the processor.

According to an example embodiment, after the active frame ends, the coordinate signal may be output to the processor.

According to an example embodiment, the coordinate signal may include an initiation signal and the sensing data, the initiation signal may be activated after the active frame ends, and the sensing data may be generated during the active frame.

According to an example embodiment, the receiving unit may compare the touch sensing value with a touch threshold value to determine whether the touch input exists.

According to an example embodiment, the sensing frame may include a scan section and a processing section, during the scan section, the touch sensor and the pressure sensor may detect an input, during the processing section, the sensor control circuit may generate the sensing data based on information about the input, and the input may include the touch input by a user's body and a noise input by noise.

According to an example embodiment, the sensor driver may provide a touch driving signal to the touch sensor and may receive a touch sensing signal from the touch sensor, and the sensor driver may provide a pressure driving signal to the pressure sensor and may receive a pressure sensing signal from the pressure sensor.

According to an example embodiment, the touch sensing value may be generated based on the touch sensing signal, and the pressure sensing value may be generated based on the pressure sensing signal.

According to an example embodiment, the touch sensor may include a plurality of touch sensing electrodes, and the plurality of touch sensing electrodes may include a plurality of first touch sensing electrodes each extending in a first direction and a plurality of second touch sensing electrodes each extending in a second direction intersecting the first direction.

According to an example embodiment, the pressure sensor may include a plurality of pressure sensing electrodes, and the plurality of pressure sensing electrodes may include a plurality of first pressure sensing electrodes each extending in the first direction and a plurality of second pressure sensing electrodes each extending in the second direction.

According to an example embodiment, the plurality of touch sensing electrodes may be arranged in a first sensing region, the plurality of pressure sensing electrodes may be arranged in a second sensing region, and the second sensing region may surround the first sensing region.

According to an example embodiment of the present disclosure, a method of driving an electronic device includes receiving sensing data generated during a first sensing frame, comparing a touch sensing value included in the sensing data with a touch threshold value, comparing a pressure sensing value included in the sensing data with a pressure threshold value when the touch sensing value is greater than the touch threshold value, determining whether to set “n” holding frames based on a comparison result between the pressure sensing value and the pressure threshold value, initiating an active frame after the “n” holding frames, and outputting a coordinate signal including the sensing data to a processor. “n” is an integer greater than or equal to “1”.

According to an example embodiment, when the pressure sensing value is greater than the pressure threshold value, the coordinate signal may include the sensing data generated during the first sensing frame, and when the pressure sensing value is less than the pressure threshold value, the coordinate signal may include the sensing data generated during the active frame that is initiated after the “n” holding frames.

According to an example embodiment, the electronic device may include a sensor layer including a touch sensor and a pressure sensor and a sensor driver that controls driving of the sensor layer, the sensor driver may provide a touch driving signal to the touch sensor and may receive a touch sensing signal from the touch sensor, and the sensor driver may provide a pressure driving signal to the pressure sensor and may receive a pressure sensing signal from the pressure sensor.

According to an example embodiment, the touch sensing value may be generated based on the touch sensing signal, and the pressure sensing value may be generated based on the pressure sensing signal.

According to an example embodiment, when the pressure sensing value is greater than the pressure threshold value, the coordinate signal may be output to the processor after a first delay time from an input time when the touch input occurs, when the pressure sensing value is less than the pressure threshold value, the coordinate signal may be output to the processor after a second delay time from the input time, and the first delay time may be less than the second delay time.

According to an example embodiment, during the first delay time, one sensing frame may be included, during the second delay time, n+1 sensing frames may be included, the one sensing frame included in the first delay time may be an active frame, one sensing frame among the n+1 sensing frames included in the second delay time may be the active frame, and each of the remaining “n” sensing frames may be the holding frame.

### BRIEF DESCRIPTION OF THE FIGURES

The above and other objects and features of the present disclosure will become apparent by describing in detail example embodiments thereof with reference to the accompanying drawings.

FIG. 1A is a plan view of an electronic device, according to an example embodiment of the present disclosure.

FIG. 1B is a diagram illustrating an interior of a vehicle in which an electronic device is placed, according to an example embodiment of the present disclosure.

FIG. 2 is a block diagram schematically illustrating an electronic device and a user's body, according to an example embodiment of the present disclosure.

FIG. 3A is a cross-sectional view of an electronic device according to an example embodiment of the present disclosure.

FIG. 3B is a cross-sectional view of an electronic device according to an example embodiment of the present disclosure.

FIG. 4 is a block diagram of a display layer and a display driving unit, according to an example embodiment of the present disclosure.

FIG. 5 is a block diagram of a sensor layer and a sensor driving unit, according to an example embodiment of the present disclosure.

FIG. 6 is a block diagram of a sensor control circuit, according to an example embodiment of the present disclosure.

FIG. 7A is a block diagram of a sensor layer and a sensor driving unit, according to an example embodiment of the present disclosure.

FIG. 7B is a timing diagram for describing driving of an electronic device, according to an example embodiment of the present disclosure.

FIG. 8A is a block diagram of a sensor layer and a sensor driving unit, according to an example embodiment of the present disclosure.

FIG. 8B is a block diagram of a sensor layer and a sensor driving unit, according to an example embodiment of the present disclosure.

FIG. 8C is a timing diagram for describing driving of an electronic device, according to an example embodiment of the present disclosure.

FIG. 9 is a flowchart illustrating a method of driving an electronic device, according to an example embodiment of the present disclosure.

FIG. 10 is a block diagram of an electronic device, according to an example embodiment.

FIG. 11 is a schematic diagram of electronic devices, according to various example embodiments.

### DETAILED DESCRIPTION

In the specification, when one component (or area, layer, part, or the like) is referred to as being “on”, “connected to”, or “coupled to” another component, it should be understood that the former may be directly on, connected to, or coupled to the latter, and also may be on, connected to, or coupled to the latter via a third intervening component.

Identical drawing symbols refer to identical components. Also, in drawings, the thickness, ratio, and dimension of components are exaggerated for effectiveness of description of technical contents. The term “and/or” includes one or more combinations of the associated listed items.

The terms “first”, “second”, etc. are used to describe various components, but the components are not limited by the terms. The terms are used solely for the purpose of distinguishing one element, component, region, layer, or portion from another element, component, region, layer, or portion. For example, without departing from the scope of the present disclosure, a first element, a first component, a first region, a first layer, or a first portion may be termed a second element, a second component, a second region, a second layer, or a second portion, and similarly, a second element, a second component, a second region, a second layer, or a second portion may also be termed a first element, a first component, a first region, a first layer, or a first portion. Singular expressions may include plural expressions unless the context clearly dictates otherwise.

Also, the terms “under”, “beneath”, “on”, “above” are used to describe a relationship between components illustrated in a drawing. The terms are relative and are described with reference to a direction indicated in the drawing.

It will be understood that the terms “include”, “comprise”, “have”, etc. specify the presence of features, numbers, steps, operations, elements, or components, described in the specification, or a combination thereof, not precluding the presence or additional possibility of one or more other features, numbers, steps, operations, elements, components, or a combination thereof.

Unless defined otherwise, all terms (including technical and scientific terms) used herein have the same meaning as commonly understood by one of ordinary skill in the art to which this disclosure belongs. In addition, terms such as terms defined in commonly used dictionaries should be interpreted as having a meaning consistent with the meaning in the context of the related technology and should not be interpreted as an ideal or excessively formal meaning unless explicitly defined in the present disclosure.

The term “when” as used herein is to be understood to encompass the phrase “in response to.” Thus, if an action is taken “when” a condition is true, false, or indeterminate, the action may be said to be taken in response to the condition being true, false, or indeterminate.

Hereinafter, example embodiments of the present disclosure will be described with reference to accompanying drawings.

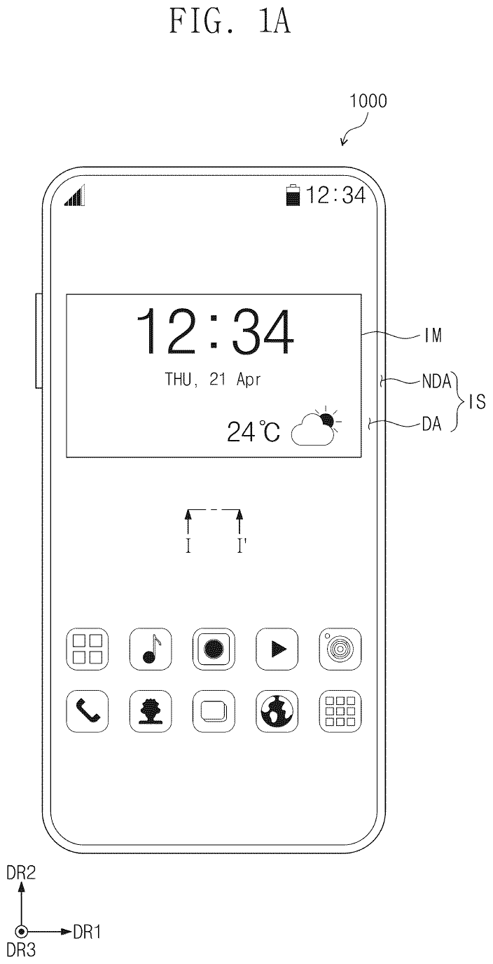

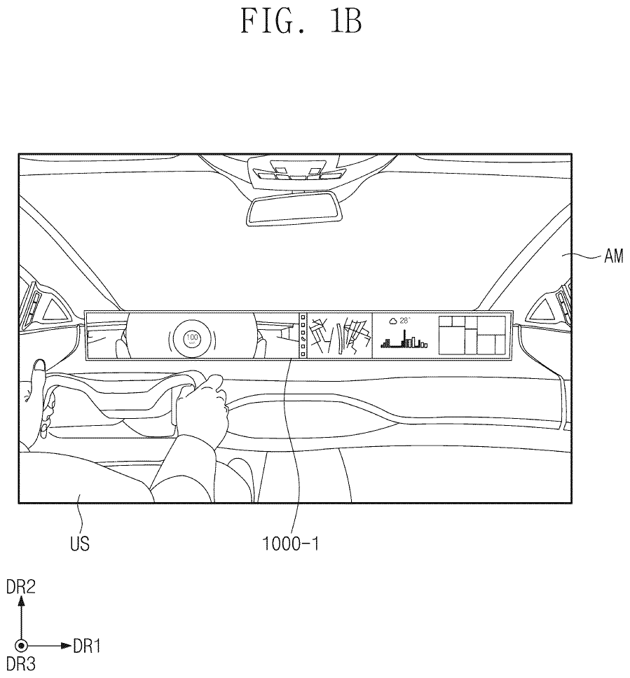

FIG. 1A is a plan view of an electronic device, according to an example embodiment of the present disclosure.

Referring to FIG. 1A, an electronic device 1000 may be a device that is activated, in response to an electrical signal. The electronic device 1000 may be applied to electronic devices such as a mobile phone, a tablet, a smart watch, a laptop computer, a computer, or a smart television. In FIG. 1A, a mobile phone is illustrated as an example.

The electronic device 1000 may display an image IM on a display surface IS parallel to each of a first direction DR1 and a second direction DR2. The display surface IS on which the image IM is displayed may correspond to a front surface of the electronic device 1000. The image IM may include a still image as well as a moving image. A third direction DR3 may indicate the normal direction of the display surface IS, that is, the thickness direction of the electronic device 1000. A front surface (or a top surface) and a back surface (or a bottom surface) of each of the layers or units described below are distinguished by the third direction DR3.

The display surface IS of the electronic device 1000 may be divided into a display area DA and a non-display area NDA. The display area DA may be an area in which the image IM is displayed. A user visually perceives the image IM through the display area DA. In this example embodiment, the display area DA is illustrated in the shape of a quadrangle whose vertexes are rounded. However, this is illustrated by way of example, and the display area DA may have various shapes, and is not limited to any one example embodiment.

The non-display area NDA is adjacent to the display area DA. The non-display area NDA may have a given color. The non-display area NDA may surround the display area DA. Accordingly, in some example embodiments, the shape of the display area DA may be defined by the shape of the non-display area NDA, as illustrated. In other example embodiments, the non-display area NDA may be disposed adjacent to only one side of the display area DA, more than one but fewer than all sides of the display area DA, or may be omitted. Some example embodiments of electronic device 1000 may also include various features from other disclosed example embodiments. Thus, the example embodiments disclosed herein are not intended to be limited to exact disclosed embodiments, unless specifically claimed to be so.

FIG. 1B is a diagram illustrating an interior of a vehicle in which an electronic device 1000-1 is placed, according to an example embodiment of the present disclosure.

Referring to FIG. 1B, the electronic device 1000-1 may be placed inside a vehicle AM. In FIG. 1B, an example embodiment is illustrated in which one electronic device 1000-1 is placed inside the vehicle AM. In other example embodiments, however, a plurality of electronic devices may be placed inside the vehicle AM. In some such example embodiments, the plurality of electronic devices may include a first electronic device placed in front of and facing a driver US and a second electronic device may be placed facing a passenger seat.

The electronic device 1000-1 may display an image necessary for driving to the driver US who is driving. For example, the electronic device 1000-1 may display speed information, vehicle status information, vehicle internal operation information, navigation information, etc. In addition, the electronic device 1000-1 may display not only information necessary for driving, but also various information unrelated to driving, such as a media channel, a productivity application, or the like.

As the electronic device 1000-1 is applied to various products (e.g., vehicles), the screen ratio (e.g., aspect ratio or length-to-width ratio) of the electronic device 1000-1 may also vary.

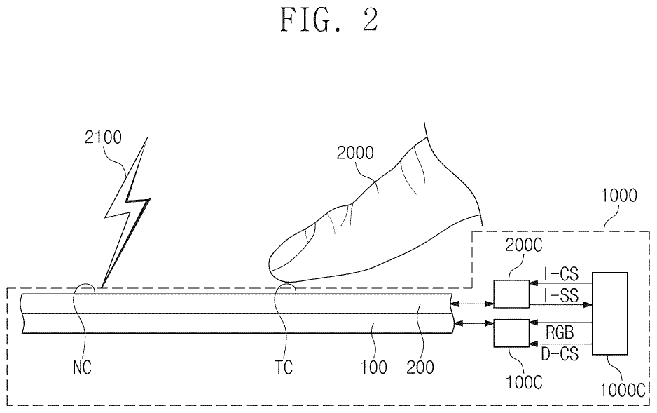

FIG. 2 is a block diagram schematically illustrating an electronic device and a user's body, according to an example embodiment of the present disclosure.

Referring to FIG. 2, the electronic device 1000 may include a display layer 100, a sensor layer 200, a display driving unit 100C, a sensor driving unit 200C, and a processor 1000C.

The display layer 100 may be a component which actually generates an image. The display layer 100 may be a light-emitting display layer, and for example, the display layer 100 may be an organic light-emitting display layer, a quantum dot display layer, a micro LED display layer, or a nano LED display layer.

The sensor layer 200 may be disposed on the display layer 100. The sensor layer 200 may detect an external input applied from the outside and/or an input due to noise. For example, the sensor layer 200 may detect a touch input TC by a body 2000 of a user. Alternatively, the sensor layer 200 may detect a noise input NC by spike noise 2100.

The processor 1000C may control overall operations of the electronic device 1000. For example, the processor 1000C may control operations of the display driving unit 100C and the sensor driving unit 200C. The processor 1000C may include at least one microprocessor, and the processor 1000C may be referred to as a host.

The display driving unit 100C may control the display layer 100. The processor 1000C may further include a graphics controller. The display driving unit 100C may receive image data RGB and a display control signal D-CS from the processor 1000C. The display control signal D-CS may include various signals. For example, the display control signal D-CS may include an input vertical synchronization signal, an input horizontal synchronization signal, a main clock, and a data enable signal. The display driving unit 100C may generate the vertical synchronization signal and the horizontal synchronization signal that control the timing of providing a signal to the display layer 100, based on the display control signal D-CS.

The sensor driving unit 200C (or, referred to as a sensor driver 200C) may control the sensor layer 200. The sensor driving unit 200C may receive a sensor control signal I-CS from the processor 1000C. The sensor control signal I-CS may include a mode determination signal for determining a driving mode of the sensor driving unit 200C and a clock signal. The sensor driving unit 200C may operate in a mode that detects the touch input TC by the body 2000 of the user based on the sensor control signal I-CS.

The sensor driving unit 200C may calculate sensing data of the touch input TC based on a signal received from the sensor layer 200 and may provide a coordinate signal I-SS having the sensing data to the processor 1000C.

The sensor driving unit 200C and the processor 1000C may be connected to each other through I²C (Inter Integrated Circuit) communication or SPI (Serial Peripheral Interface) communication.

The processor 1000C allows an operation corresponding to a user input to be executed based on the coordinate signal I-SS. For example, the processor 1000C may operate the display driving unit 100C to display a new application image on the display layer 100 based on the coordinate signal I-SS. The coordinate signal I-SS may include an initiation signal INT (refer to FIG. 6) and sensing data SD (refer to FIG. 6).

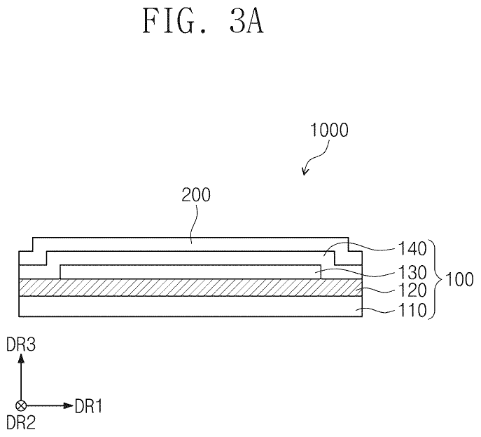

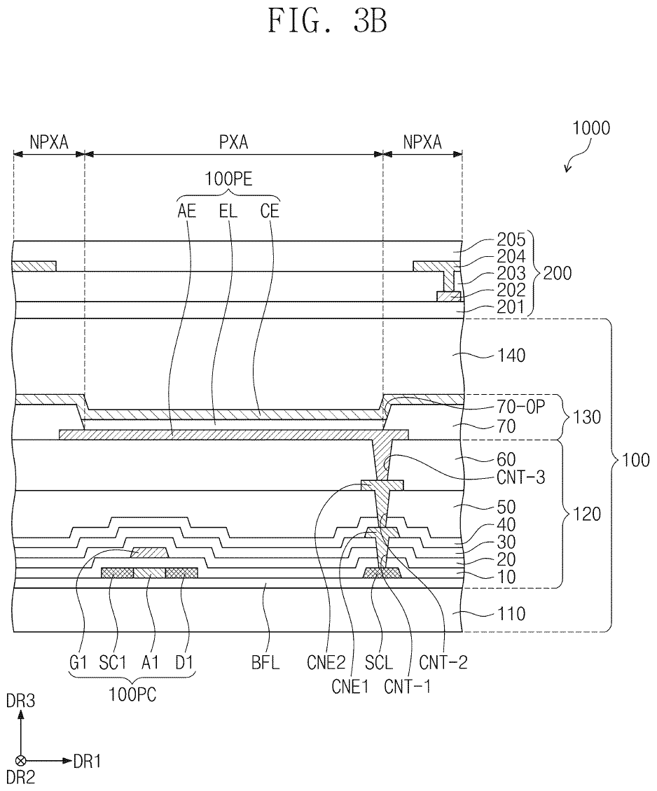

FIG. 3A is a cross-sectional view of an electronic device according to an example embodiment of the present disclosure.

Referring to FIG. 3A, the electronic device 1000 may include the display layer 100 and the sensor layer 200. The display layer 100 may include a base layer 110, a circuit layer 120, a light emitting element layer 130, and an encapsulation layer 140.

The base layer 110 may be a member that provides a base surface on which the circuit layer 120 is disposed. The base layer 110 may be a glass substrate, a metal substrate, or a polymer substrate. However, the example embodiment is not limited thereto, and the base layer 110 may be an inorganic layer, an organic layer, or a composite material layer.

The base layer 110 may have a multi-layered structure. For example, the base layer 110 may include a first synthetic resin layer, a silicon oxide (SiOx) layer disposed on the first synthetic resin layer, an amorphous silicon (a-Si) layer disposed on the silicon oxide layer, and a second synthetic resin layer disposed on the amorphous silicon layer. The silicon oxide layer and the amorphous silicon layer may be referred to as a ‘base barrier layer’.

Each of the first and second synthetic resin layers may include polyimide-based resin. Also, each of the first and second synthetic resin layers may include at least one of acrylate-based resin, methacrylate-based resin, polyisoprene-based resin, vinyl-based resin, epoxy-based resin, urethane-based resin, cellulose-based resin, siloxane-based resin, polyamide-based resin, and perylene-based resin. Meanwhile, the wording “[material type]-based resin” in the specification indicates that the specified resin includes a functional group of that material type.

The circuit layer 120 may be disposed on the base layer 110. The circuit layer 120 may include an insulating layer, a semiconductor pattern, a conductive pattern, and a signal line. An insulating layer, a semiconductor layer, and a conductive layer may be formed on the base layer 110 through a coating or deposition process, and the insulating layer, the semiconductor layer, and the conductive layer may then be selectively patterned through a plurality of photolithography processes. Thereafter, the semiconductor pattern, the conductive pattern, and the signal line included in the circuit layer 120 may be formed.

The light emitting element layer 130 may be disposed on the circuit layer 120. The light emitting element layer 130 may include a light emitting element. For example, the light emitting element layer 130 may include an organic light emitting material, a quantum dot, a quantum rod, a micro-LED, or a nano-LED.

The encapsulation layer 140 may be disposed on the light emitting element layer 130. The encapsulation layer 140 may protect the light emitting element layer 130 from foreign substances such as moisture, oxygen, and dust particles.

The sensor layer 200 may be formed on the display layer 100 through a successive process. In this case, the sensor layer 200 may be expressed as being directly disposed on the display layer 100. The wording “being directly disposed” may indicate that a third component is not intervened between the sensor layer 200 and the display layer 100. For example, an additionally adhesive member may not be interposed between the sensor layer 200 and the display layer 100. Alternatively, the sensor layer 200 may be bonded to the display layer 100 through an intervening adhesive member. The adhesive member may include a typical adhesive or a sticking agent.

FIG. 3B is a cross-sectional view of an electronic device according to an example embodiment of the present disclosure. In the description of FIG. 3B, the same reference numerals are assigned to the same components described with reference to FIG. 3A, and thus the descriptions thereof are omitted to avoid redundancy.

Referring to FIG. 3B, at least one inorganic layer may be formed on an upper surface of the base layer 110. The inorganic layer may include at least one of aluminum oxide, titanium oxide, silicon oxide, silicon oxynitride, zirconium oxide, and hafnium oxide. The inorganic layer may be formed of multiple layers. The inorganic layer or layers may constitute a barrier layer and/or a buffer layer. In an example embodiment, the display layer 100 is illustrated as including a buffer layer BFL.

The buffer layer BFL may improve a bonding force between the base layer 110 and a semiconductor pattern. The buffer layer BFL may include a silicon oxide layer and a silicon nitride layer, and the silicon oxide layers and the silicon nitride layers may be alternately laminated.

The semiconductor pattern may be disposed on the buffer layer BFL. The semiconductor pattern may include polysilicon. However, the present disclosure is not limited thereto, and the semiconductor pattern may include amorphous silicon, low-temperature polycrystalline silicon, or oxide semiconductor.

FIG. 3B illustrates only a portion of the semiconductor pattern, and the semiconductor pattern may be further disposed in another region. Semiconductor patterns may be arranged across pixels according to a specific rule. An electrical property of the semiconductor pattern may vary depending on whether it is doped or not. The semiconductor pattern may include a first area having higher conductivity and a second area having lower conductivity. The first area may be doped with an N-type dopant or a P-type dopant. A P-type transistor may include a doping region doped with the P-type dopant, and an N-type transistor may include a doping region doped with the N-type dopant. The second region may be a non-doping region or may be a region doped at a concentration lower than the concentration of the first region.

A conductivity of the first region is greater than a conductivity of the second region, and the first region may actually serve as an electrode or a signal line. The second region may correspond to an active (or channel) of a transistor. In other words, a portion of the semiconductor pattern may be an active region of a transistor, another portion of the semiconductor pattern may be a source or a drain of the transistor, and another portion of the semiconductor pattern may be a connection electrode or a connection signal line.

Each pixel may be expressed by an equivalent circuit including 7 transistors, one capacitor, and a light emitting element, and the equivalent circuit of the pixel may be modified in various forms. One transistor 100PC and one light emitting element 100PE included in the pixel are illustrated in FIG. 3B by way of example.

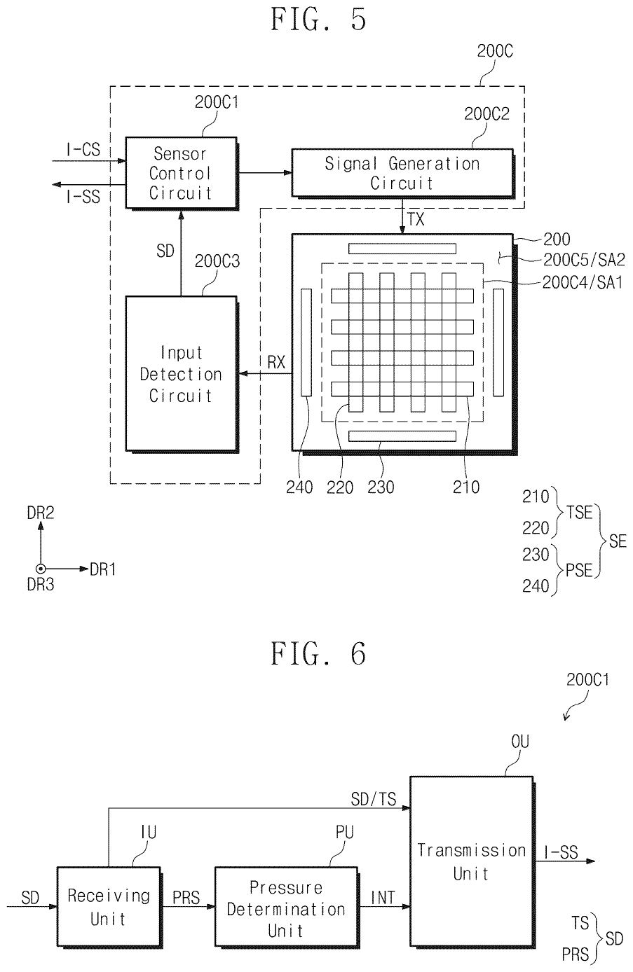

The transistor 100PC may include a source SC1, an active A1, a drain D1, and a gate G1. The source SC1, the active A1, and the drain D1 may be formed from a semiconductor pattern. The source SC1 and the drain D1 may extend from the active A1 in directions facing away from each other on a cross-section. A portion of a connection signal line SCL formed from the semiconductor pattern is illustrated in FIG. 5. Although not separately illustrated, the connection signal line SCL may be connected with the drain D1 of the transistor 100PC on a plane.

A first insulating layer 10 may be disposed on the buffer layer BFL. The first insulating layer 10 may overlap a plurality of pixels in common and may cover the semiconductor pattern. The first insulating layer 10 may be an inorganic layer and/or an organic layer, and may have a single-layer structure or a multi-layer structure. The first insulating layer 10 may include at least one of aluminum oxide, titanium oxide, silicon oxide, silicon nitride, silicon oxynitride, zirconium oxide, and hafnium oxide. According to an example embodiment, the first insulating layer 10 may be a silicon oxide layer in a single layered structure. The first insulating layer 10 and an insulating layer of the circuit layer 120, which is to be described later, may be an inorganic layer and/or an organic layer, and may have a single-layer structure or a multi-layer structure. The inorganic layer may include at least one of the above-described materials, but is not limited thereto.

The gate G1 is disposed on the first insulating layer 10. The gate G1 may be a portion of a metal pattern. The gate G1 overlaps the active A1. The gate G1 may function as a mask in a process of doping the semiconductor pattern.

A second insulating layer may be disposed on the first insulating layer 10 and may cover the gate G1. The second insulating layer 20 may overlap the pixels in common. The second insulating layer 20 may be an inorganic layer and/or an organic layer, and may have a single-layer structure or a multi-layer structure. The second insulating layer 20 may include at least one of silicon oxide, silicon nitride, and silicon oxy nitride. In this example embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer structure or a multi-layer structure. In this example embodiment, the third insulating layer 30 may have a multi-layer structure including a silicon oxide layer and a silicon nitride layer.

A first connection electrode CNE1 may be disposed on the third insulating layer 30. The first connection electrode CNE1 may be connected with the connection signal line SCL through a contact hole CNT-1 formed through the first insulating layer 10, the second insulating layer 20, and the third insulating layer 30.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light emitting element layer 130 may be disposed on the circuit layer 120. The light emitting element layer 130 may include the light emitting element 100PE. For example, the light emitting element layer 130 may include an organic light emitting material, a quantum dot, a quantum rod, a micro-LED, or a nano-LED. Hereinafter, the description will be given under the condition that the light emitting element 100PE is an organic light emitting element, but an example embodiment is not particularly limited thereto.

The light emitting element 100PE may include a first electrode AE, a light emitting layer EL, and a second electrode CE. The first electrode AE may be disposed on the sixth insulating layer 60. The first electrode AE may be connected to the second connection electrode CNE2 through a contact hole CNT-3 penetrating the sixth insulating layer 60.

A pixel defining film 70 may be disposed on the sixth insulating layer 60 and may cover a portion of the first electrode AE. An opening 70-OP is defined in the pixel defining film 70. The opening 70-OP of the pixel defining film 70 exposes at least a portion of the first electrode AE.

A display area DA (refer to FIG. 1A) may include an emission area PXA and a non-emission area NPXA adjacent to the emission area PXA. The non-emission area NPXA may surround the emission area PXA. In the present example embodiment, the emission area PXA is defined to correspond to the portion of the first electrode AE, which is exposed by the opening 70-OP.

The light emitting layer EL may be disposed on the first electrode AE. The light emitting layer EL may be disposed in an area corresponding to the opening 70-OP. In other words, the light emitting layer EL may be independently formed for respective pixels. In the case where light emitting layers EL are separately formed for respective pixels, each of the light emitting layers EL may emit a light of at least one of a blue color, a red color, and a green color. However, the present disclosure is not limited thereto, and the light emitting layer EL may be connected with the pixels in common. In this case, the light emitting layer EL may provide blue light or white light.

The second electrode CE may be disposed on the light emitting layer EL. The second electrode CE may have an integral shape and may be commonly disposed in the plurality of pixels.

Although not illustrated, a hole control layer may be interposed between the first electrode AE and the light emitting layer EL. The hole control layer may be disposed in common in the emission area PXA and the non-emission area NPXA. The hole control layer may include a hole transport layer and may further include a hole injection layer. An electron control layer may be interposed between the light emitting layer EL and the second electrode CE. The electron control layer may include an electron transport layer and may further include an electron injection layer. The hole control layer and the electron control layer may be formed, in common, in a plurality of pixels by using an open mask.

The encapsulation layer 140 may be disposed on the light emitting element layer 130. The encapsulation layer 140 may include an inorganic layer, an organic layer, and an inorganic layer sequentially stacked, and layers constituting the encapsulation layer 140 are not limited thereto.

The inorganic layers may protect the light emitting element layer 130 from moisture and oxygen, and the organic layer may protect the light emitting element layer 130 from a foreign material such as dust particles. The inorganic layers may include a silicon nitride layer, a silicon oxynitride layer, a silicon oxide layer, a titanium oxide layer, or an aluminum oxide layer. The organic layer may include, but is not limited to, an acrylic-based organic layer.

The sensor layer 200 may be formed on the display layer 100 through a successive process. In this case, the sensor layer 200 may be expressed as being directly disposed on the display layer 100. The wording “~being directly disposed~” may indicate that a third component is not intervened between the sensor layer 200 and the display layer 100. In other words, an additionally adhesive member may not be interposed between the sensor layer 200 and the display layer 100. Alternatively, the sensor layer 200 may be bonded to the display layer 100 through an adhesive member. The adhesive member may include a typical adhesive or a sticking agent.

The sensor layer 200 may include a base insulating layer 201, a first conductive layer 202, a sensing insulating layer 203, a second conductive layer 204, and a cover insulating layer 205.

The base insulating layer 201 may be an inorganic layer including at least one of silicon nitride, silicon oxy nitride, and silicon oxide. Alternatively, the base insulating layer 201 may be an organic layer including an epoxy resin, an acrylic resin, or an imide-based resin. The base insulating layer 201 may have a single-layer structure or may be a multi-layer structure in which a plurality of layers are stacked along the third direction DR3.

Each of the first conductive layer 202 and the second conductive layer 204 may have a single-layer structure or a multi-layer structure in which a plurality of layers are stacked along the third direction DR3.

A conductive layer of a single-layer structure may include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), or indium zinc tin oxide (IZTO), etc. In addition, the transparent conductive layer may include a conductive polymer such as PEDOT, metal nanowires, graphene, etc.

The multi-layered conductive layer may include metal layers. The metal layers may, for example, have a three-layer structure of titanium/aluminum/titanium. The multi-layered conductive layer may include at least one metal layer and at least one transparent conductive layer.

At least one of the sensing insulating layer 203 and the cover insulating layer 205 may include an inorganic film. The inorganic film may include at least one of aluminum oxide, titanium oxide, silicon oxide, silicon oxynitride, zirconium oxide, and hafnium oxide.

At least one of the sensing insulating layer 203 and the cover insulating layer 205 may include an organic film. The organic film may include at least one of acrylate-based resin, methacrylate-based resin, polyisoprene-based resin, vinyl-based resin, epoxy-based resin, urethane-based resin, cellulose-based resin, siloxane-based resin, polyimide-based resin, polyamide-based resin, and perylene-based resin.

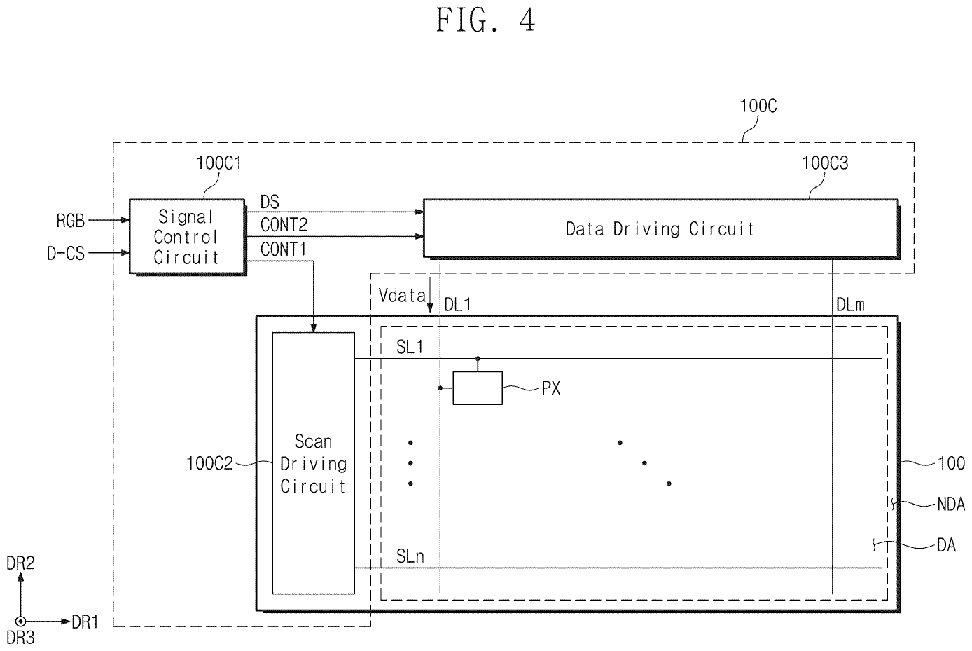

FIG. 4 is a block diagram of a display layer and a display driving unit according to an example embodiment of the present disclosure.

Referring to FIG. 4, the display layer 100 may include a plurality of scan lines SL1 to SLn, a plurality of data lines DL1 to DLm, and a plurality of pixels PX. Each of the plurality of pixels PX may be connected with a corresponding data line of the plurality of data lines DL1 to DLm and may be connected with a corresponding scan line of the plurality of scan lines SL1 to SLn. In an example embodiment of the present disclosure, the display layer 100 may further include light emission control lines, and the display driving unit 100C may further include a light emission driving circuit that provides control signals to the light emission control lines. The configuration of the display layer 100 is not particularly limited.

The display layer 100 may be defined as the display area DA and the non-display area NDA. The display area DA may be defined as an area where the image IM (refer to FIG. 1A) is displayed (i.e., the area where the image is displayed). The non-display area NDA is adjacent to the display area DA. Then the non-display area NDA may be an area where the image IM (refer to FIG. 1A) is not actually displayed. For example, the non-display area NDA may surround the display area DA. However, this is illustrated by way of an example. The non-display area NDA may be defined in various shapes, not limited to any one example embodiment.

The display driving unit 100C may include a signal control circuit 100C1, a scan driving circuit 100C2, and a data driving circuit 100C3.

The signal control circuit 100C1 may receive the image data RGB and the display control signal D-CS from the processor 1000C (refer to FIG. 2). The display control signal D-CS may include various signals. For example, the display control signal D-CS may include a vertical synchronization signal, a horizontal synchronization signal, a main clock, and a data enable signal.

The signal control circuit 100C1 may generate a first control signal CONT1 based on the display control signal D-CS, and may output the first control signal CONT1 to the scan driving circuit 100C2.

The signal control circuit 100C1 may generate a second control signal CONT2 based on the display control signal D-CS, and may output the second control signal CONT2 to the data driving circuit 100C3.

In addition, the signal control circuit 100C1 may output a driving signal DS obtained by processing the image data RGB to match the operating condition of the display layer 100 to the data driving circuit 100C3. The first control signal CONT1 and the second control signal CONT2 are signals necessary for the operation of the scan driving circuit 100C2 and the data driving circuit 100C3, and are not particularly limited thereto.

The scan driving circuit 100C2 may drive the plurality of scan lines SL1 to SLn in response to the first control signal CONT1. In an example embodiment of the present disclosure, the scan driving circuit 100C2 may be formed in the same process as the circuit layer 120 (refer to FIG. 3B) in the display layer 100, but is not limited thereto. For example, the scan driving circuit 100C2 may be implemented with an integrated circuit (IC), for electrical connection with the display layer 100, the integrated circuit IC may be directly mounted in a given area of the display layer 100 or may be mounted on a separate printed circuit board in a chip on film (COF) manner.

The data driving circuit 100C3 may output data gray scale voltage Vdata for driving the plurality of data lines DL1 to DLm in response to the second control signal CONT2 and the data signal DS from the signal control circuit 100C1. The data driving circuit 100C3 may be implemented as an integrated circuit and may be directly mounted on a predetermined area of the display layer 100 or on a separate printed circuit board in a chip on film (COF) manner to be electrically connected to the display layer 100, but is not particularly limited thereto. For example, the data driving circuit 100C3 may be formed in the same process as the circuit layer 120 (refer to FIG. 3B) in the display layer 100.

FIG. 5 is a block diagram of a sensor layer and a sensor driving unit, according to an example embodiment of the present disclosure.

Referring to FIG. 5, the sensor layer 200 may include a touch sensor 200C4 and a pressure sensor 200C5. The touch sensor 200C4 and the pressure sensor 200C5 may be activated in response to an electrical signal. For example, the touch sensor 200C4 may detect the touch input TC (refer to FIG. 2), and the pressure sensor 200C5 may detect a pressure. The touch sensor 200C4 may be disposed in a first sensing area SA1, and the pressure sensor 200C5 may be disposed in a second sensing area SA2. As an example of the present disclosure, the first sensing area SA1 may overlap with the display area DA (refer to FIG. 1A) of the electronic device 1000 (refer to FIG. 1A), and the second sensing area SA2 may overlap with the non-display area NDA (refer to FIG. 1A) of the electronic device 1000. The second sensing area SA2 may surround the first sensing area SA1.

The sensor layer 200 may include a sensing electrode SE. The sensing electrode SE may include a touch sensing electrode TSE and a pressure sensing electrode PSE. The touch sensing electrode TSE may be included in the touch sensor 200C4 and may be disposed in the first sensing area SA1. The touch sensing electrode TSE may be provided in plurality, and the plurality of touch sensing electrodes TSE may include a plurality of first touch sensing electrodes 210 and a plurality of second touch sensing electrodes 220. Each of the plurality of first touch sensing electrodes 210 may extend along the first direction DR1, and the plurality of first touch sensing electrodes 210 may be spaced apart from each other in the second direction DR2. Each of the plurality of second touch sensing electrodes 220 may extend along the second direction DR2, and the plurality of second touch sensing electrodes 220 may be spaced apart from each other in the first direction DR1. The plurality of second touch sensing electrodes 220 may be insulated and crossed with each of the plurality of first touch sensing electrodes 210.

The pressure sensing electrode PSE may be included in the pressure sensor 200C5 and may be disposed in the second sensing area SA2. The pressure sensing electrode PSE may be provided in plurality, and the plurality of pressure sensing electrodes PSE may include a plurality of first pressure sensing electrodes 230 and a plurality of second pressure sensing electrodes 240. Each of the plurality of first pressure sensing electrodes 230 may extend along the first direction DR1, and each of the plurality of second pressure sensing electrodes 240 may extend in the second direction DR2. As an example of the present disclosure, FIG. 5 illustrates the pressure sensing electrode PSE including two first pressure sensing electrodes 230 and two second pressure sensing electrodes 240. In this case, the first pressure sensing electrodes 230 may be spaced apart from each other in the second direction DR2 with the touch sensing electrode TSE interposed therebetween, and the second pressure sensing electrodes 240 may be spaced apart from each other in the first direction DR1 with the touch sensing electrode TSE interposed therebetween. However, the present disclosure is not limited thereto, and the pressure sensing electrode PSE may also include one first pressure sensing electrode 230 and one second pressure sensing electrode 240. Pressure sensing electrodes PSE may include, but are not limited to, piezoresistive electrodes, capacitive electrodes, electrochemical electrodes, and/or micro-electromechanical sensors (MEMS). A touch sensing electrode TSE may include a capacitance sensing electrode, or some other suitable type of touch-sensing electrode.

The sensor driving unit 200C may control the driving of the sensor layer 200. The sensor driving unit 200C may receive the sensor control signal I-CS from the processor 1000C (refer to FIG. 2), may provide the coordinate signal I-SS to the processor 1000C.

The sensor driving unit 200C may include a sensor control circuit 200C1, a signal generation circuit 200C2, and an input detection circuit 200C3. The sensor control circuit 200C1, the signal generation circuit 200C2, and the input detection circuit 200C3 may be implemented in a single chip, or some of the sensor control circuit 200C1, the signal generation circuit 200C2, and the input detection circuit 200C3 and other parts may be implemented in different chips.

The sensor control circuit 200C1 controls the operation of the signal generation circuit 200C2, and may calculate the coordinates of the external input and the pressure of the external input from the sensing signal received from the input detection circuit 200C3, or analyze the information transmitted from the external device from the modulation signal received from the input detection circuit 200C3.

The signal generation circuit 200C2 may provide a driving signal TX (or an output signal) to the sensor layer 200. The signal generation circuit 200C2 may output the driving signal TX that matches the sensing frame to the sensor layer 200.

The input detection circuit 200C3 may receive a sensing signal RX (or reception signal) from the sensor layer 200. The sensing signal RX may be an analog signal. For example, the input detection circuit 200C3 may amplify and then filter the received analog signal. The input detection circuit 200C3 may convert the filtered signal into a digital signal. For example, the input detection circuit 200C3 may convert the sensing signal RX into the sensing data SD so as to be output to the sensor control circuit 200C1.

FIG. 6 is a block diagram of a sensor control circuit, according to an example embodiment of the present disclosure.

Referring to FIGS. 2 and 6, the sensor control circuit 200C1 may include a receiving unit IU, a pressure determination unit PU, and a transmission unit OU.

The receiving unit IU (or, referred to as a receiving circuit IU) may receive the sensing data SD from the input detection circuit 200C3 (refer to FIG. 5). As an example of the present disclosure, the sensing data SD may include a touch sensing value TS and a pressure sensing value PRS. The touch sensing value TS may include information about the coordinates of the input, and the pressure sensing value PRS may include information about the pressure of the input. The receiving unit IU may determine whether the touch sensing value TS included in the sensing data SD is greater than or equal to a preset touch threshold value. The touch threshold value may be a reference value for determining whether the input occurs. When the receiving unit IU determines that the touch sensing value TS is greater than or equal to the touch threshold value, the receiving unit IU may determine that an input exists in the sensor layer 200. In this case, the receiving unit IU may output the pressure sensing value PRS included in the sensing data SD to the pressure determination unit PU. When the receiving unit IU determines that the touch sensing value TS is less than the touch threshold value, the receiving unit IU may determine that an input does not exist. In this case, the receiving unit IU may not output the pressure sensing value PRS to the pressure determination unit PU.

The pressure determination unit PU (or, referred to as a pressure determination circuit PU) may receive the pressure sensing value PRS from the receiving unit IU. The pressure determination unit PU may determine whether the pressure sensing value PRS is greater than or equal to the preset pressure threshold value. The pressure threshold value may be a reference value for determining whether an input occurs. In this example embodiment, when the pressure determination unit PU determines that the pressure sensing value PRS is greater than or equal to the pressure threshold value, the input may be determined as the touch input TC by the body 2000 of the user. In this case, the pressure determination unit PU may immediately output the initiation signal INT to the transmission unit OU. When the pressure determination unit PU determines that the pressure sensing value PRS is less than the pressure threshold value, the input may be determined as the noise input NC due to the spike noise 2100. In this case, the pressure determination unit PU may output the initiation signal INT to the transmission unit OU after a preset delay time.

The transmission unit OU (or, referred to as a transmission circuit OU) may receive the sensing data SD from the receiving unit IU. Alternatively, as an example of the present disclosure, the touch sensing value TS may be received. In addition, the transmission unit OU may receive the initiation signal INT immediately or after a preset delay time based on the determination result of the pressure determination unit PU. When the transmission unit OU receives the initiation signal INT, the transmission unit OU is activated and may generate the coordinate signal I-SS based on the sensing data SD (or the touch sensing value TS) received at the time of activation from the receiving unit IU. The coordinate signal I-SS may further include the initiation signal INT. The transmission unit OU may output the coordinate signal I-SS to the processor 1000C.

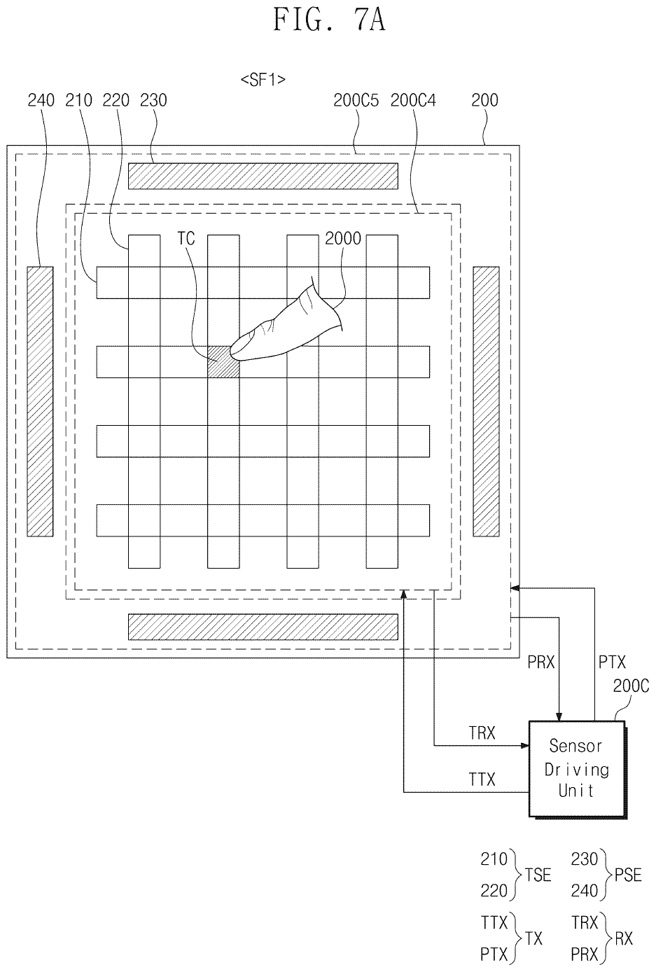

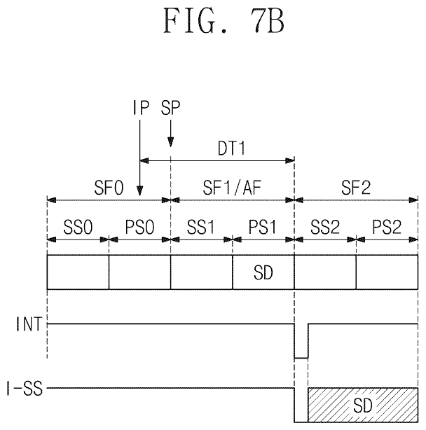

FIG. 7A is a block diagram of a sensor layer and a sensor driving unit, according to an example embodiment of the present disclosure. FIG. 7B is a timing diagram for describing driving of an electronic device, according to an example embodiment of the present disclosure.

Referring to FIG. 2, FIG. 7A and FIG. 7B, the touch sensor 200C4 may detect the touch input TC by the body 2000 of the user, and the pressure sensor 200C5 may detect pressure. FIG. 7A illustrates a scene where the touch input TC is input to the sensor layer 200 at the initiation time of a first sensing frame SF1.

The sensor driving unit 200C may drive the sensor layer 200 in units of sensing frames SF0, SF1, and SF2 to detect the touch input TC. The sensing frames SF0 to SF2 may have a driving frequency of 120 Hz (Hertz). In detail, the sensing frames SF0 to SF2 may be generated at a cycle of 8.3 ms (milliseconds). However, this is an example, and the driving frequency of the sensing frame SF according to an example embodiment of the present disclosure is not limited thereto. In this example embodiment, three sensing frames (e.g., the 0-th sensing frame SF0, the first sensing frame SF1, the second sensing frame SF2) are illustrated as an example.

Each of the sensing frames SF0 to SF2 may include scan sections SS0, SS1, and SS2 and processing sections PS0, PS1, and PS2. The processing sections PS0, PS1, and PS2 may respectively follow the scan sections SS0, SS1, and SS2. During the scan sections SS0 to SS2, the sensor layer 200 may receive the driving signal TX from the sensor driving unit 200C, and the sensor driving unit 200C may receive the sensing signal RX from the sensor layer 200. In an example of the present disclosure, the driving signal TX may include a touch driving signal TTX and a pressure driving signal PTX, and the sensing signal RX may include a touch sensing signal TRX and a pressure sensing signal PRX. The touch sensing electrode TSE may receive the touch driving signal TTX from the sensor driving unit 200C and may output the touch sensing signal TRX to the sensor driving unit 200C. The pressure sensing electrode PSE may receive the pressure driving signal PTX from the sensor driving unit 200C and the pressure sensing electrode PSE may output the pressure sensing signal PRX to the sensor driving unit 200C.

During the processing section PS0 to PS2, the sensor driving unit 200C may generate the sensing data SD. The sensing data SD may include the touch sensing value TS and the pressure sensing value PRS. During the processing section PS0 to PS2, the sensor driving unit 200C may generate the touch sensing value TS based on the touch sensing signal TRX and may generate the pressure sensing value PRS based on the pressure sensing signal PRX. During the processing section PS0 to PS2, the receiving unit IU (refer to FIG. 6) may compare the touch sensing value TS with the touch threshold value, and the pressure determination unit PU (refer to FIG. 6) may compare the pressure sensing value PRS with the pressure threshold value. Depending on the comparison result, whether to transmit the coordinate signal I-SS from the transmission unit OU to the processor 1000C may be determined.

The touch input TC may occur at an input time IP. The input time IP may be a middle time of the 0-th sensing frame SF0. In this case, the sensor driving unit 200C may not detect the touch input TC during the 0-th scan section SS0, and the sensor driving unit 200C may not process information about the touch input TC during the 0-th processing section PS0. When the input time IP corresponds to the middle time of the 0-th sensing frame SF0, the sensor driving unit 200C may detect and process the touch input TC from a sensing time SP. In an example embodiment of the present disclosure, the 0-th sensing frame SF0 may be omitted.

The sensing time SP may be the initiation time of the first sensing frame SF1. During the first scan section SS1, the sensor layer 200 may receive the driving signal TX from the sensor driving unit 200C, and the sensor driving unit 200C may receive the sensing signal RX from the sensor layer 200. During the first processing section PS1, the sensor driving unit 200C may generate the sensing data SD based on the sensing signal RX. In addition, during the first processing section PS1, the sensor driving unit 200C may determine whether the input is a normal input by the body 2000 of the user based on the sensing data SD. As in the example embodiment illustrated in FIGS. 7A and 7B, when the input to the sensor layer 200 does not include the noise input NC due to the spike noise 2100 and only includes the touch input TC by the body 2000 of the user, the first sensing frame SF1 may be an active frame AF.

After the active frame AF ends, the second sensing frame SF2 may be initiated. During the second sensing frame SF2, the initiation signal INT is activated, and the sensor driving unit 200C may output the coordinate signal I-SS to the processor 1000C. For example, during the second scan section SS2 of the second sensing frame SF2, the initiation signal INT may have activation level (or low level). The coordinate signal I-SS may include the initiation signal INT and the sensing data SD generated during the active frame AF. The processor 1000C may receive the sensing data SD from the sensor driving unit 200C in response to the activated initiation signal INT.

A first delay time DT1 may be defined as a time required for the sensor driving unit 200C to detect the touch input TC and to output the coordinate signal I-SS to the processor 1000C after the touch input TC occurs. In this example embodiment, one sensing frame SF1 may be included during the first delay time DT1.

According to the present disclosure, as in the example embodiment illustrated in FIGS. 7A and 7B, when the pressure determination unit PU determines that the pressure sensing value PRS is greater than the pressure threshold value, it may be determined that the input to the sensor layer 200 does not include the noise input NC due to the spike noise 2100 and only includes the touch input TC by the body 2000 of the user. In this case, without setting a separate holding frame, the coordinate signal I-SS including the sensing data SD generated during the first sensing frame SF1 may be output to the processor 1000C. Accordingly, an electronic device with an improved response speed may be provided.

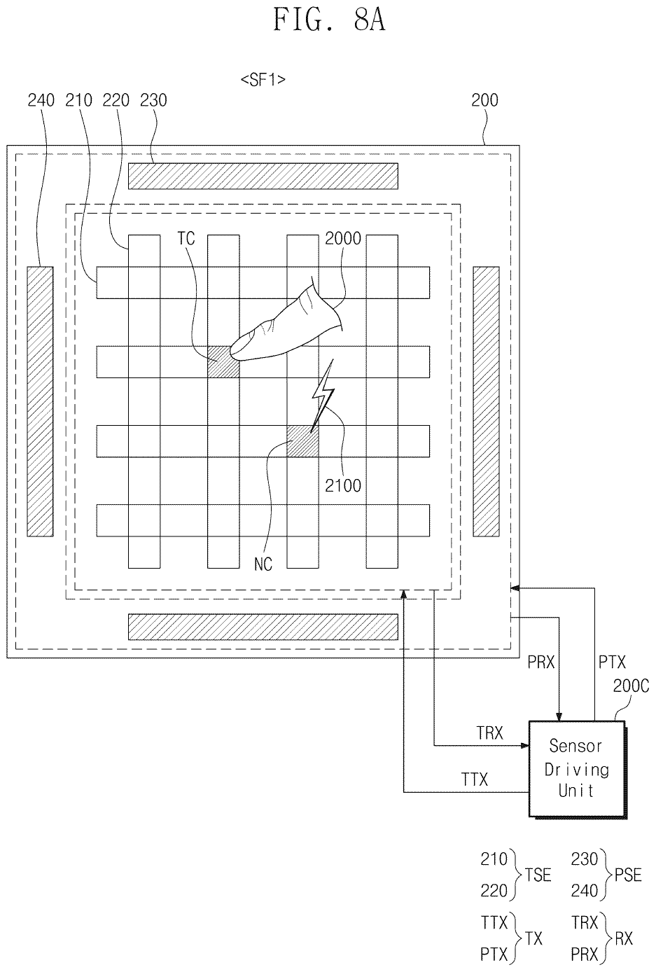

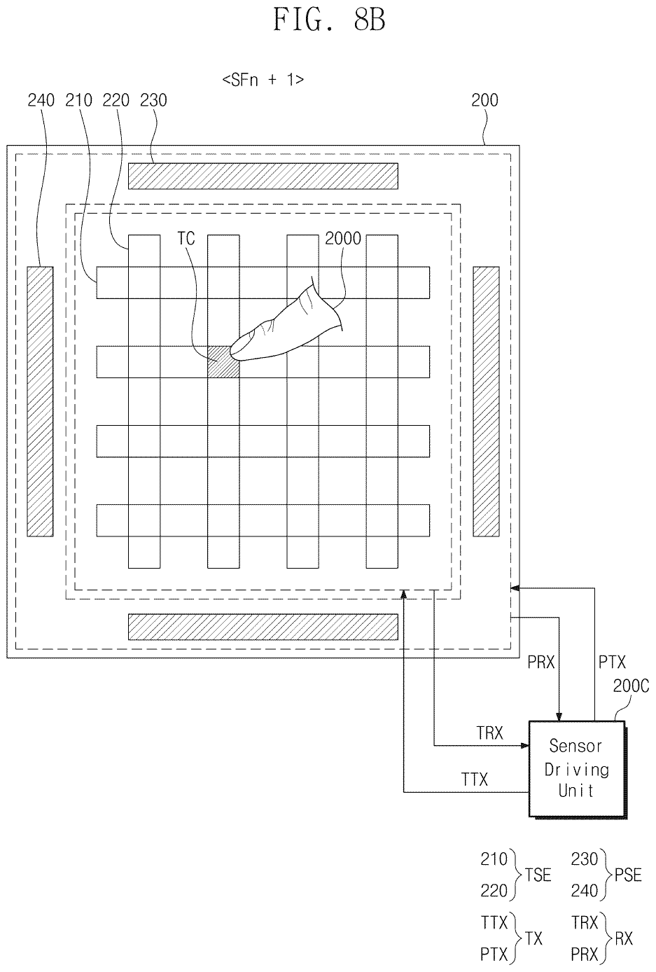

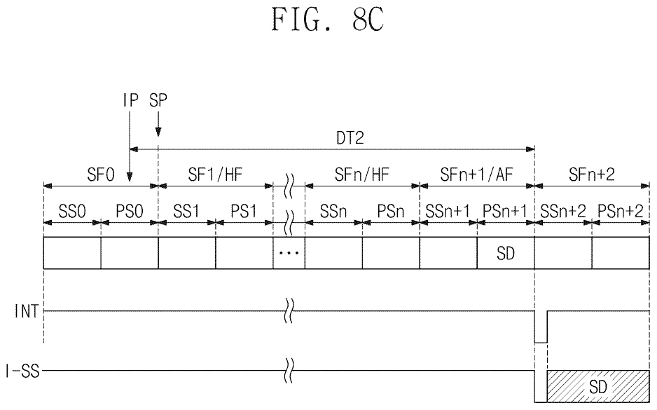

FIGS. 8A and 8B are block diagrams of a sensor layer and a sensor driving unit, according to an example embodiment of the present disclosure. FIG. 8C is a timing diagram for describing driving of an electronic device, according to an example embodiment of the present disclosure.

Referring to FIG. 2, FIG. 8A, FIG. 8B, and FIG. 8C, the touch sensor 200C4 may detect the touch input TC by the body 2000 of the user and the noise input NC due to the spike noise 2100, and the pressure sensor 200C5 may detect pressure. FIG. 8A illustrates a view in which the touch input TC by the body 2000 of the user and the noise input NC due to the spike noise 2100 are detected at the initiation time of the first sensing frame SF1, and FIG. 8B illustrates a view in which touch input TC by the body 2000 of the user is detected at the initiation time of an (n+1)-th sensing frame SFn+1. As an example of the present disclosure, the noise input NC may be an input caused by a single-shot noise that occurs suddenly for a very short time due to the touch input TC. The example embodiments illustrated in FIGS. 8A, 8B, and 8C include the same configuration as the example embodiments illustrated in FIGS. 7A and 7B except that noise input NC due to the touch input TC is generated, and therefore, the same drawing symbols are used for the same configuration and additional descriptions are omitted to avoid redundancy.

The sensor driving unit 200C may drive the sensor layer 200 in units of sensing frames SF0, SF1−SFn, SFn+1, and SFn+2 to detect an input. In this example embodiment, n+3 sensing frames SF0−SFn+2 are illustrated as an example.

As illustrated in FIG. 8A, the input time IP may be the middle time of the 0-th sensing frame SF0, and the sensing time SP may be the initiation time of the first sensing frame SF1. At the input time IP, the touch input TC is input to the sensor layer 200, and from the sensing time SP, detection and processing of the touch input TC and the noise input NC due to the spike noise 2100 may be performed. During the first scan section SS1, the sensor layer 200 may receive the driving signal TX from the sensor driving unit 200C, and the sensor driving unit 200C may receive the sensing signal RX from the sensor layer 200. During the first processing section PS1, the sensor driving unit 200C may generate the sensing data SD based on the sensing signal RX. In addition, the sensor driving unit 200C may determine whether the touch input TC and the noise input NC are normal inputs by the body 2000 of the user based on the sensing data SD during the first processing section PS1. As in the example embodiment illustrated in FIG. 8A and FIG. 8B, when the input includes the noise input NC due to the spike noise 2100, the sensor driving unit 200C may determine the input as an abnormal input and “n” holding frames HF may proceed after the first sensing frame SF1. That is, the first to n-th sensing frames SF1 to SFn may be holding frames HF. Since the spike noise 2100 is a short-lived noise, the noise input NC may be removed after “n” holding frames HF elapse.

After the “n” holding frames HF end, the (n+1)-th sensing frame SFn+1 may be initiated. The (n+1)-th sensing frame SFn+1 may be referred to as a last sensing frame. The (n+1)-th sensing frame SFn+1 may be the active frame AF. As illustrated in FIG. 8B, during the (n+1)-th sensing frame SFn+1, only the touch input TC by the body 2000 of the user is input to the sensor layer 200, and the spike noise 2100 is removed, so that the noise input NC due to the spike noise 2100 may not be input. During the active frame AF, the sensing data SD may be generated based on the touch input TC by the body 2000 of the user. That is, the sensing data SD generated during the active frame AF may not include information about the noise input NC.

After the active frame AF ends, the (n+2)-th sensing frame SFn+2 may be initiated. During the (n+2)-th sensing frame SFn+2, the initiation signal INT is activated, and the sensor driving unit 200C may output the coordinate signal I-SS to the processor 1000C. The coordinate signal I-SS may include the initiation signal INT and the sensing data SD generated during the active frame AF. The processor 1000C may receive the sensing data SD from the sensor driving unit 200C in response to the activated initiation signal INT.

A second delay time DT2 may be defined as a time required for the sensor driving unit 200C to detect the touch input TC and to output the coordinate signal I-SS to the processor 1000C after the touch input TC occurs. Since the holding frame HF is included during the second delay time DT2, the second delay time DT2 may be longer than the first delay time DT1 (refer to FIG. 7B).

In the present example embodiment, n+1 sensing frames SF1 to SFn+1 may be included during the second delay time DT2. In this case, “n” sensing frames SF1 to SFn may be holding frames HF, and the (n+1)-th sensing frame SFn+1 may be the active frame AF. The holding frame HF may precede the active frame AF. After the holding frame HF ends, the coordinate signal I-SS may not be output to the processor 1000C. After the active frame AF ends, the coordinate signal I-SS may be output to the processor 1000C. That is, the sensing data SD generated during the holding frame HF is not output to the processor 1000C, and the sensing data SD generated during the active frame AF may be output to the processor 1000C.

According to the present disclosure, when the pressure determination unit PU determines that the pressure sensing value PRS is less than the pressure threshold value, as in the example embodiments illustrated in FIGS. 8A, 8B, and 8C, the input to the sensor layer 200 may be determined to include the noise input NC due to the spike noise 2100. In this case, by setting the “n” holding frames HF, the time until the coordinate signal I-SS is output to the processor 1000C after the touch input TC may be delayed. Accordingly, the coordinate signal I-SS including information about the input from which noise is removed may be output to the processor 1000C.

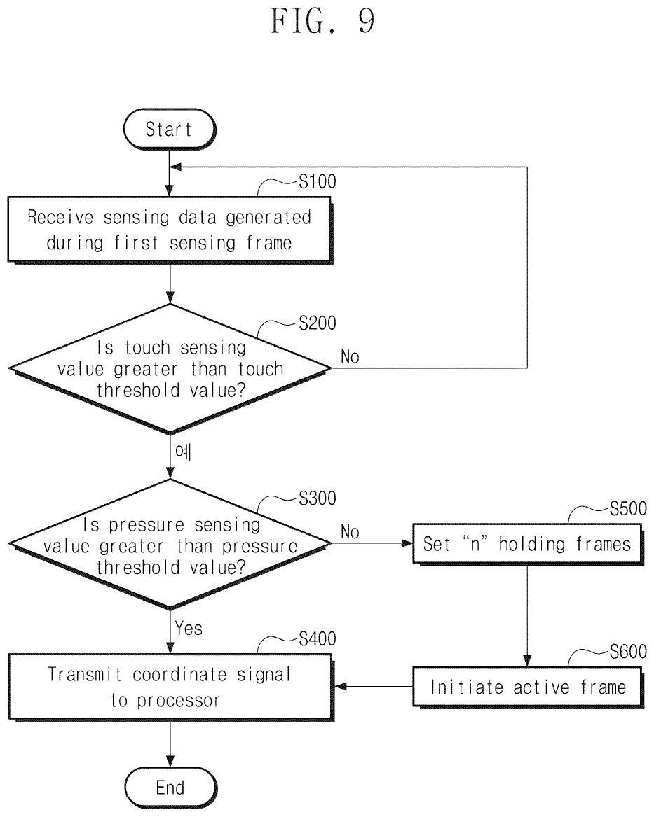

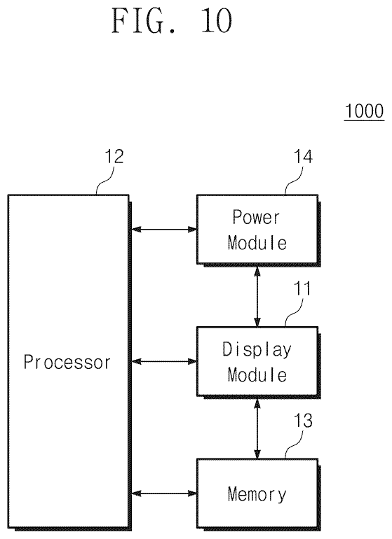

FIG. 9 is a flowchart illustrating a method of driving an electronic device, according to an example embodiment of the present disclosure.

Referring to FIG. 6, FIG. 7B, FIG. 8C, and FIG. 9, the receiving unit IU may receive the sensing data SD generated during the first sensing frame SF1 (S100). The sensing data SD may include the touch sensing value TS and the pressure sensing value PRS. The receiving unit IU may determine whether the touch sensing value TS included in the sensing data SD is greater than a preset touch threshold value (S200). When the receiving unit IU determines that the touch sensing value TS is less than the touch threshold value, the receiving unit IU may determine that the input is not detected. When the receiving unit IU determines that the touch sensing value TS is greater than the touch threshold value, the receiving unit IU may determine that the input is detected. In this case, the receiving unit IU may output the sensing data SD to the pressure determination unit PU. The pressure determination unit PU may determine whether the pressure sensing value PRS included in the sensing data SD is greater than a preset pressure threshold value (S300). When the pressure determination unit PU determines that the pressure sensing value PRS is greater than the pressure threshold value, the pressure determination unit PU may transmit the coordinate signal I-SS to the processor 1000C (refer to FIG. 2) (S400). In this case, the first sensing frame SF1 may be the active frame AF, and the coordinate signal I-SS may include the sensing data SD received during operation S100.

When the pressure determination unit PU determines that the pressure sensing value PRS is less than the pressure threshold value, the “n” holding frames HF may be set after the touch input (S500). The active frame AF may be initiated after “n” holding frames HF (S600). Afterwards, the coordinate signal I-SS may be transmitted to the processor 1000C (S400). In this case, the coordinate signal I-SS may include the sensing data SD generated during operation S600.

FIG. 10 is a block diagram of an electronic device, according to an example embodiment. Referring to FIG. 10, the electronic device 1000 according to an example embodiment may include a display module 11, a processor 12, a memory 13, and a power module 14.

The processor 12 may include at least one of a central processing unit (CPU), an application processor (AP), a graphics processing unit (GPU), a communication processor (CP), an image signal processor (ISP), and a controller. The processor 12 may correspond to the processor 1000C described with reference to FIG. 2.

The memory 13 may store data information necessary for operations of the processor 12 or the display module 11. When the processor 12 executes an application stored in the memory 13, an image data signal and/or an input control signal is transferred to the display module 11, and the display module 11 may process the received signal and may output image information through a display screen.

The power module 14 may include a power supply module, such as a power adapter or a battery device, and a power conversion module that converts power supplied by the power supply module to generate power required for the operation of the electronic device 1000.

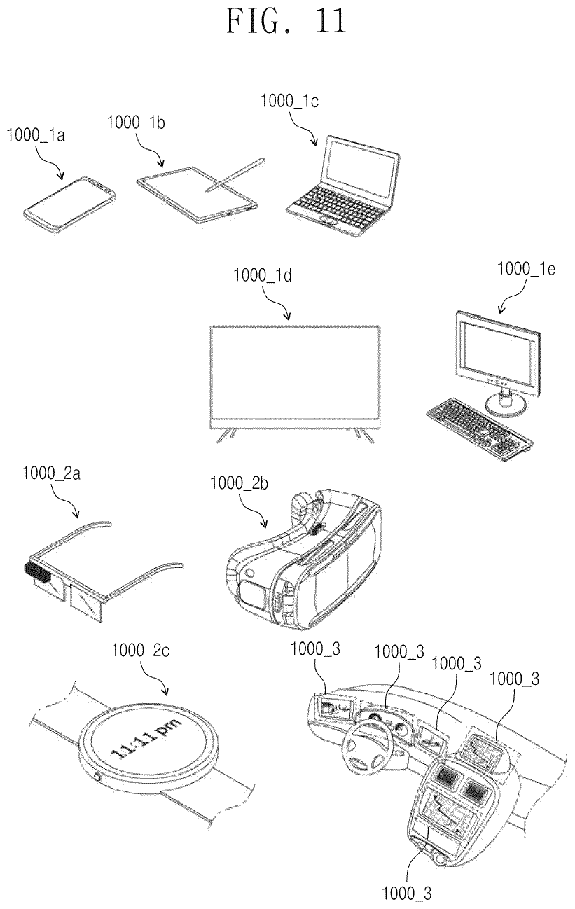

FIG. 11 is a schematic diagram of electronic devices, according to various example embodiments.

Referring to FIG. 11, various electronic devices according to example embodiments may include not only image display electronic devices such as a smart phone 1000_1a, a tablet PC 1000_1b, a laptop computer 1000_1c, a TV 1000_1d, a desk monitor 1000_1e, but also wearable electronic devices including display modules such as smart glasses 1000_2a, a head-mounted display 1000_2b, a smart watch 1000_2c, etc., and vehicle electronic devices 1000_3 including display modules such as a CID (Center Information Display) placed on an instrument panel, a center fascia, or a dashboard of a vehicle, a room mirror display, etc.

According to an example embodiment of the present disclosure, the sensor driving unit may have a delay time from the input time when a touch input occurs until the coordinate signal is output to the processor. A holding frame and an active frame may be included in the delay time. The sensor driving unit may compare a pressure sensing value with a preset pressure threshold value, and the holding frame may be omitted based on the comparison result. Accordingly, the active frame may be initiated immediately after the touch input, so that the electronic device with an improved response speed may be provided.

Although the present disclosure has been described above with reference to example embodiments thereof, it will be understood by those skilled in the art or having ordinary knowledge in the art that various modifications and substitutions are possible, without departing from the spirit and the technical scope of the present disclosure as set forth in the claims below.

Any units, modules, and/or functional blocks described herein or illustrated in the FIGS. may be implemented using hardware components or a combination of software components and hardware components. For example, the hardware components may include microcontrollers, memory modules, sensors, amplifiers, band-pass filters, analog to digital converters, and processing devices, or the like. A processing device may be implemented using one or more hardware device(s) configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor, or any other device capable of responding to and executing instructions in a defined manner. The processor may be a hardware processor such as central processing unit (CPU), a multi-processor, a distributed processing system, an application specific integrated circuit (ASIC), and/or a suitable hardware processing unit. The processing device(s) may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors, multi-core processors, distributed processing, or the like, that when executing instructions according to firmware or software configure the processing device as a special purpose computer for controlling one or more operations thereof.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, and/or computer storage medium or device. The software also may be distributed over network coupled computer systems so that the software is stored and executed in a distributed fashion. The software and data may be stored by one or more computer readable recording mediums.

Example embodiments have been described above with the aid of method steps illustrating the performance of specified functions and relationships thereof. The boundaries and sequence of these functional building blocks and method steps have been defined herein for convenience of description. Alternate boundaries and sequences can be defined, so long as the specified functions and relationships are appropriately performed. Any such alternate boundaries or sequences are thus within the scope and spirit of the claims.

In various example embodiments herein, reference may have been made to various circuit elements, including but not limited to capacitors, resistor, inductors, switches, amplifiers, comparators, filters, and transistors. Various different types of digital, analog, active and/or passive components are available for use in implementing the example embodiments. For example, as discussed above, pseudo-resistors can be substituted for passive resistors. Additionally various different transistor types can be used depending on the implementation, whether positive or negative logic is used, manufacturing processes employed, or the like. Furthermore, unless specifically stated otherwise herein, there are many available types of filters, comparators, switches, and the like that can be used to implement the example embodiments.

Accordingly, the technical scope of the present disclosure is not limited to the detailed description of this specification, but should be determined by the claims.

What is claimed is:

1. An electronic device comprising:
a sensor layer including a touch sensor for detecting a touch input and a pressure sensor for detecting a pressure;
a sensor driver configured to drive the sensor layer in units of sensing frames, the sensor driver including a sensor control circuit;
a processor configured to control an operation of the sensor driver, and
wherein the sensor control circuit includes:
a receiving circuit configured to receive sensing data including a touch sensing value and a pressure sensing value; and
a pressure determination circuit configured to determine whether pressure occurs based on the pressure sensing value,
in response to the pressure sensing value being greater than a pressure threshold value, the sensor control circuit outputs a coordinate signal to the processor after a first delay time from an input time when the touch input occurs,
in response to the pressure sensing value being less than the pressure threshold value, the sensor control circuit outputs the coordinate signal to the processor after a second delay time from the input time, and
the first delay time is less than the second delay time.

2. The electronic device of claim 1, wherein
the first delay time includes one sensing frame,
the second delay time includes n+1 sensing frames are included, and
“n” is an integer greater than or equal to “1”.

3. The electronic device of claim 2, wherein
the one sensing frame included in the first delay time is an active frame,
a last sensing frame among the n+1 sensing frames included in the second delay time is the active frame, and
each remaining sensing frame of the n+1 sensing frames included in the second delay time is a holding frame.

4. The electronic device of claim 3, wherein each holding frame included in the second delay time precedes the active frame included in the second delay time.

5. The electronic device of claim 3, wherein the coordinate signal is not output to the processor after the holding frame ends.

6. The electronic device of claim 3, wherein the coordinate signal is output to the processor after the active frame ends.

7. The electronic device of claim 6, wherein
the coordinate signal includes an initiation signal and the sensing data,
the initiation signal being activated after the active frame ends, and
the sensing data being generated during the active frame.

8. The electronic device of claim 1, wherein the receiving circuit compares the touch sensing value with a touch threshold value to determine whether the touch input exists.

9. The electronic device of claim 1, wherein
a sensing frame includes a scan section and a processing section,
during the scan section, the touch sensor and the pressure sensor detect an input,
during the processing section, the sensor control circuit generates the sensing data based on information about the input, and
the input includes the touch input by a user's body and a noise input by noise.

10. The electronic device of claim 1, wherein
the sensor driver provides a touch driving signal to the touch sensor and receives a touch sensing signal from the touch sensor, and
wherein the sensor driver provides a pressure driving signal to the pressure sensor and receives a pressure sensing signal from the pressure sensor.

11. The electronic device of claim 10, wherein
the touch sensing value is generated based on the touch sensing signal, and
the pressure sensing value is generated based on the pressure sensing signal.

12. The electronic device of claim 1, wherein
the touch sensor includes a plurality of touch sensing electrodes, and
the plurality of touch sensing electrodes includes:
a plurality of first touch sensing electrodes each extending in a first direction; and
a plurality of second touch sensing electrodes each extending in a second direction intersecting the first direction.

13. The electronic device of claim 12, wherein
the pressure sensor includes a plurality of pressure sensing electrodes, and the plurality of pressure sensing electrodes includes:
a plurality of first pressure sensing electrodes each extending in the first direction; and
a plurality of second pressure sensing electrodes each extending in the second direction.

14. The electronic device of claim 13, wherein
the plurality of touch sensing electrodes are arranged in a first sensing region,
the plurality of pressure sensing electrodes are arranged in a second sensing region, and
the second sensing region surrounds the first sensing region.

15. A method of driving an electronic device, the method comprising:
receiving sensing data generated during a first sensing frame;
comparing a touch sensing value included in the sensing data with a touch threshold value;
comparing a pressure sensing value included in the sensing data with a pressure threshold value in response to the touch sensing value being greater than the touch threshold value;
determining whether to set “n” holding frames based on a comparison result between the pressure sensing value and the pressure threshold value;
initiating an active frame after the “n” holding frames; and
outputting a coordinate signal including the sensing data to a processor,
wherein “n” is an integer greater than or equal to “1”.

16. The method of claim 15, further comprising
in response to the pressure sensing value being greater than the pressure threshold value, generating the coordinate signal to include the sensing data generated during the first sensing frame, and
in response to the pressure sensing value being less than the pressure threshold value, generating the coordinate signal to include the sensing data generated during the active frame that is initiated after the “n” holding frames.

17. The method of claim 15, further comprising:
transmitting a touch driving signal from a sensor driver to a touch sensor included in a sensor layer of the electronic device;
receiving a touch sensing signal from the touch sensor;
transmitting a pressure driving signal from the sensor driver to a pressure sensor included in the sensor layer of the electronic device; and
receiving a pressure sensing signal from the pressure sensor.

18. The method of claim 17, wherein
the touch sensing value is generated based on the touch sensing signal, and
the pressure sensing value is generated based on the pressure sensing signal.

19. The method of claim 15, wherein
in response to the pressure sensing value being greater than the pressure threshold value, outputting the coordinate signal to the processor after a first delay time from an input time when a touch input occurs,
in response to the pressure sensing value being less than the pressure threshold value, outputting the coordinate signal to the processor after a second delay time from the input time, and
the first delay time being less than the second delay time.

20. The method of claim 19, wherein
the first delay time includes one sensing frame, the one sensing frame being an active frame, and
the second delay time includes n+1 sensing frames,
last sensing frame among the n+1 sensing frames included in the second delay time is the active frame, and
each remaining sensing frame of the n+1 sensing frames is a holding frame.
